(19) United States
(12) Patent Application Publication
(10) Pub. No.: US 2026/0279369 A1
(43) Pub. Date: Sep. 17, 2026

(54) AUDIO PROCESSOR WITH A STEERED AUDIO BANDWIDTH EXTENSION

(71) Applicant: Fraunhofer-Gesellschaft zur Förderung der angewandten Forschung e.V., München (DE)

(72) Inventors: Martin MÜLLER, Erlangen (DE); Guillaume FUCHS, Erlangen (DE); Domenico TIZIANI, Erlangen (DE); Stefan REUSCHL, Erlangen (DE); Manfred LUTZKY, Erlangen (DE); Goran MARKOVIC, Erlangen (DE)

(73) Assignee: Fraunhofer-Gesellschaft zur Förderung der angewandten Forschung e.V., München (DE)

(21) Appl. No.: 19/671,050

(22) Filed: May 7, 2026

Related U.S. Application Data
(63) Continuation of application No. PCT/EP2024/081758, filed on Nov. 8, 2024.

(30) Foreign Application Priority Data
Nov. 10, 2023 (EP) 23209165.2

(51) Int. Cl. G10L 19/087; G10L 19/12

(52) U.S. Cl. CPC G10L 19/087; G10L 19/12

(57) ABSTRACT

An audio processor or coder for processing or coding a signal, the processor or coder comprising: a band-limited entity or coder configured to provide or code a band-limited signal of the signal; and a bandwidth extension entity or coder configured to provide or code an extended-band signal of the signal, the provided or decoded extended-band signal comprising a mixture of a first extended-band excitation and a second extended-band excitation; wherein the bandwidth extension entity or coder is configured to generate the first extended-band excitation and a noise generator configured to generate random noise as the second extended-band excitation; wherein the mixture is controlled via a steering factor derived from a characteristic output or parameter of the band-limited entity or coder.

### CROSS-REFERENCES TO RELATED APPLICATIONS

This application is a continuation of copending International Application No. PCT/EP2024/081758, filed Nov. 8, 2024, which is incorporated herein by reference in its entirety, and additionally claims priority from European Application No. EP 23209165.2, filed Nov. 10, 2023, which is incorporated herein by reference in its entirety.

### BACKGROUND OF THE INVENTION

Embodiments of the present invention refer to an audio processor as well as to corresponding methods. The audio processor may be a decoder and an encoder using the audio processor or part of a decoder or encoder. Thus embodiment refer to an encoder and decoder. Further embodiments provide a bandwidth extension technique (BWE) called Waveform Envelope Synchronized Pulse Excitation (WESPE) steering or whitening using a voicing factor derived from coding parameters of a Code-Excited Linear Prediction (CELP). Preferred embodiments provide a solution employing information derived from the baseband coding for steering the mixing, and more specifically employing a voicing estimation done on the energetic contribution of the codebooks of the baseband coder or CELP and/or coder type transmitted.

Bandwidth extension (BWE) is a technique used in speech coding to enhance the quality of speech transmission in situations where the available bandwidth or the possible bit-rate is limited. In essence, it is a method of expanding the frequency range of a speech baseband coder, like CELP, beyond the Nyquist frequency of its internal sampling rate, which can improve the perceived quality of the reconstructed speech signal at the decoder side. Usually, the bandwidth extension techniques in audio coding, transmit no, or very few additional parameters, and required therefore no or very limited extra bit-rate over the baseband coder.

The Waveform Envelope Synchronized Pulse Excitation WESPE is an example of an efficient bandwidth extension, which can retain the original high-frequency (HF) fine structure, while being more controllable than the systematic copying, shifting, mirroring, or non-linear operations, usually used in this type of system. The procedure relies on the extraction of a relevant time envelope and the position of pulses at its maxima. In this way, WESPE is able to extent harmonic structures to HF, and for noisier signal could also create pretty noisy fine structure.

Bandwith extension is very well studied and established technique, already deployed in different existing standard like, HeAAC and 3GPP EVS. It usually built over a baseband coder, like a speech coder of type CELP or a generic transform-based audio coding, like AAC or TCX. In consequence, bandwidth extension can be performed either in time domain, or in frequency domain or in both domains. However, the great majority of the techniques dissociate the modeling of the frequency fine structure, called excitation in Time Domain, and coarse spectral structure, also called spectral envelope.

For great bit saving, the principle is based on generating the fine structured high frequency content from the transmitted low frequency content from the baseband coder. The high frequencies are then spectral shaped and/or post processed before being mixed at the decoder side to the decoded baseband. The whole process can be steered by transmitted parameters.

The main problem is usually that HF content generated from LF may not fit original fine structure. It is particularly true if copy-up (like in SBR) or mirroring (like in AMR-WB+) of the LF content is used to generate the HF fine structure. Non-linearity (like TD-BWE) operations are able to preserve some consistency in the harmonicity or during transients, but turns out to be difficult to control and to steer.

On the other hand, WESPE is advantageous in that, in contrast to non-linearity processing, it provides a readily controlled procedure by placing pulses at maxima positions of the time envelope. However, the extraction of a relevant temporal envelope is then essential and critical, especially in a system with hard constraints on complexity and algorithmic delay.

A drawback of the prior art is that unpleased artifacts, such as busyness and roughness, especially for noisy signals such as noise or unvoiced speech phonemes can occur. Therefore there is need for an improved approach.

It is an objective of the present invention to improve WESPE coding with respect to unpleased effects, like artifacts.

### SUMMARY

An embodiment may have an audio processor for processing a signal, the audio processor comprising: a band-limited entity configured to provide a band-limited signal; and a bandwidth extension entity configured to provide an extended-band signal, the extended-band signal comprising a mixture of a first extended-band excitation and a second extended-band excitation; wherein the bandwidth extension entity is configured to generate the first extended-band excitation; and a noise generator configured to generate random noise as the second extended-band excitation; wherein the mixture is controlled via a steering factor derived from a characteristic output or a parameter of the band-limited entity; wherein the bandwidth extension entity is configured to generate the first extended-band excitation from a temporal envelope derived from the band-limited signal, especially a linear prediction residual of the band-limited signal or of an excitation modelling the linear prediction residual of the band-limited signal, by use of an envelope determiner; wherein the bandwidth extension entity is configured to generate the first extended-band excitation by placing pulses in relation to values, wherein the values are determined by an analyzer analyzing the temporal envelope, the pulses being weighted using weights derived from the temporal envelope.

Another embodiment may have an audio coder for coding an audio signal, the coder comprising: a band-limited entity configured to code the signal to acquire a band-limited signal; and a bandwidth extension entity configured to code an extended-band signal, and comprising a mixture of a first extended-band excitation and a second extended-band excitation; wherein the bandwidth extension entity is configured to generate the first extended-band excitation and a noise generator configured to generate random noise as the second extended-band excitation; wherein the mixture is controlled via a steering factor derived from a characteristic output or parameter of the band-limited entity; wherein the bandwidth extension entity is configured to generate the first extended-band excitation from a temporal envelope derived from the band-limited signal, especially a linear prediction residual of the band-limited signal or of an excitation modelling the linear prediction residual of the band-limited signal, by use of an envelope determiner; wherein the bandwidth extension entity is configured to generate the first extended-band excitation by placing pulses in relation to values, wherein the values are determined by an analyzer analyzing the temporal envelope, the pulses being weighted using weights derived from the temporal envelope.

Another embodiment may have a decoder comprising the audio processor according to the invention and comprising a baseband decoder for decoding the band-limited signal by use of the band-limited entity and a bandwidth extension decoder for decoding the extended-band signal, wherein the bandwidth extension decoder comprises the bandwidth extension entity.

Another embodiment may have an encoder comprising the audio processor according to the invention and comprising a baseband encoder for encoding the band-limited signal by use of the band-limited entity and a bandwidth extension encoder for encoding the extended-band signal, wherein the bandwidth extension encoder comprises the bandwidth extension entity.

Another embodiment may have a method for processing a signal, the method comprising: providing a band-limited signal; and providing an extended-band signal, the extended-band signal comprising a mixture of a first extended-band excitation and a second extended-band excitation; generating the first extended-band excitation from a temporal envelope derived from the band-limited signal, especially a linear prediction residual of the band-limited signal or of an excitation modelling the linear prediction residual of the band-limited signal; and generating random noise as the second extended-band excitation; wherein the mixture is controlled via a steering factor derived from a characteristic output or parameter of the band-limited entity; wherein the generating the first extended-band excitation comprises placing pulses in relation to values, wherein the values are determined by analyzing the temporal envelope, the pulses being weighted using weights derived from the temporal envelope.

Another embodiment may have a non-transitory digital storage medium having a computer program stored thereon to perform the method for processing a signal, the method comprising: providing a band-limited signal; and providing an extended-band signal, the extended-band signal comprising a mixture of a first extended-band excitation and a second extended-band excitation; generating the first extended-band excitation from a temporal envelope derived from the band-limited signal, especially a linear prediction residual of the band-limited signal or of an excitation modelling the linear prediction residual of the band-limited signal; and generating random noise as the second extended-band excitation; wherein the mixture is controlled via a steering factor derived from a characteristic output or parameter of the band-limited entity; wherein the generating the first extended-band excitation comprises placing pulses in relation to values, wherein the values are determined by analyzing the temporal envelope, the pulses being weighted using weights derived from the temporal envelope, when said computer program is run by a computer.

An embodiment of the present invention provides audio processor like a coder for processing or a signal, the audio processor (coder) comprises a band-limited entity or coder and a bandwidth extension entity (BWE coder). The band-limited entity (coder) is configured to provide or code a band-limited signal of the signal, like a low-band signal. The bandwidth extension entity (BWE coder) is configured to provide or code an extended (additional) band, like a high band signal of the signal, the extended band signal comprising a mixture of a first extended-band excitation a second extended-band excitation. The BWE (band width extension) entity (coder) may comprise a WESPE or another coder configured to generate the first extended-band excitation and a noise generator configured to generate random noise as the second extended-band excitation. The mixture is controlled via a steering factor derived from outputs, parameters or characteristics of the band-limited entity (coder).

Embodiments of the present invention are based on the finding that mixing two types of excitations, e.g. one issued from WESPE and another from randomly generated noise can be combined so as to overcome the drawbacks. According to embodiments, optimal mixing is found by avoiding transmitting additional information, this by exploiting characteristics of the band-limited entity or coder and especially CELP. The WESPE coder may have an envelope determiner for determining a temporal envelope of at least a portion of a linear prediction residual of the band-limited audio signal or an excitation modelling the linear prediction residual of the band-limited audio signal; an analyzer for analyzing the temporal envelope to determine (certain) values of the temporal envelope; an excitation generator for generating the first band-extended excitation, by placing pulses in relation to the determined (certain) values, wherein the pulses are weighted using weights derived from the temporal envelope.

According to embodiments, the audio processor is configured for exploiting the characteristics or parameter of the band-limited entity from the limited band signal. According to further embodiments or additional embodiments the band-limited entity and the bandwidth extension entity operate in the residual or excitation domain (involving a linear prediction).

Note, the band-limited entity and/or the bandwidth extension entity may comprise a Linear Prediction Coding (LPC). For example, band-limited entity may be implemented as simple provider for the limited band signal or as processor which can perform the band limitation (filtering). According to embodiments, the band-limited entity/coder may comprise a long-term prediction, a pitch analysis or a tonal analysis. According to embodiments, the band-limited entity may comprise a voice coder, especially a CELP coder. Thus, it is advantageously possible to use these kinds of coders for speech transmission. According to embodiments, this concept may be used together with CELP. Note, band-limiting means that it/the band-limited entity is doing something like low-pass filtering of the original signal.

In order to control the mixing adequately a steering factor can be used. For example, the steering factor is a voice factor or a prediction gain or depends on the coder type or the pitch gain or a tonality factor. According to embodiments, a concept for exploiting the information provided by or derivable from the baseband coder is used.

Embodiments of the present invention provide a decoder using the above mentioned processor or coder. Here, the band-limited entity is used for decoding the band-limited, e.g. low band signal of the signal to be decoded, wherein the BWE entity is used to decode at least the extended-band signal, e.g. high band signal. According to embodiments, the BWE decoder may comprise the BWE entity and the band-limited entity comprising the baseband coder.

Another embodiment provides another audio processor using the processor (coder) having a band-limited entity/coder and the BWE entity/coder.

A further embodiment provides a method for processing or coding a signal, the method comprising the two basic steps of baseband processing or coding a low band signal of the signal and BWE processing or coding a high band signal of the signal. The high band signal comprising a mixture of the first HF excitation and a second HF excitation. The BWE coding may comprise WESPE coding by WESPE coding or another coding to generate the first HF excitation and noise generator configured to generate random noise of the second HF excitation.

Further embodiments may be computer implemented. Thus, an embodiment provides a computer program for performing the steps of the above defined method.

### BRIEF DESCRIPTION OF THE DRAWINGS

Embodiments of the present invention will be detailed subsequently referring to the appended drawings, in which:

FIG. 1a shows a basic implementation of a coder comprising a baseband coder and a BWE coder according to a basic embodiment;

FIG. 1b shows a basic implementation of a corresponding method according to an embodiment.

FIG. 2 shows a block diagram for a level zero of the split bond encoder, involving the baseband encoder and the BWE encoder and according to further embodiments;

FIG. 3 shows a schematic illustration of two bond systems realized with block transforms, namely DFTs according to further embodiments;

FIG. 4 shows a schematic block diagram of a BWE encoder according to further embodiments; and

FIG. 5 shows a schematic block diagram of a level zero of the splitting band decoder, involving the baseband decoder and the BWE decoder according to embodiments.

### DETAILED DESCRIPTION OF THE INVENTION

Below, embodiments of the present invention will subsequently be discussed referring to the enclosed figures, wherein identical reference numbers are provided to objects having identical or similar functions so that the description thereof is interchangeable and mutually applicable.

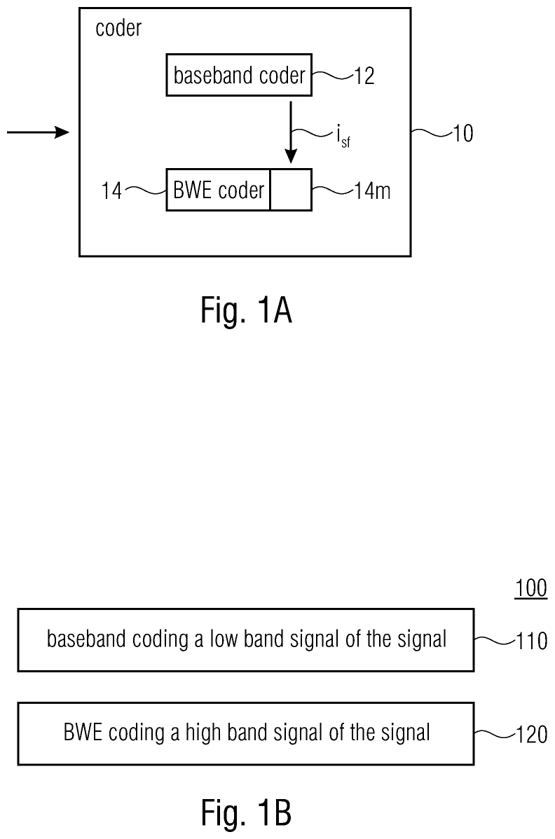

FIG. 1a shows an audio processor 10, especially a coder 10 having two integrated processor or coders, namely a baseband processor 12 and a BWE entity 14 (/coder or bandwidth extension coder). The BWE entity 14 can be enhanced by a mixer 14M which may be an integral part or a separate part. The mixer 14M may be connected to the baseband processor 12 so as to be controlled or to form the controlling of the mixer 14M dependent on an information from the band-limited entity 12, also referred to as band-limited processor or baseband processor.

Both coders the band-limited entity or coder 12 and the bandwidth extension (BWE) entity or coder 14 receive an input signal to be processed or coded, so as to output, for example, a band-limited signal, e.g. a low band signal by the band-limited entity 12 and an excitation signal, e.g. high band signal by the BWE entity 14. The band-limited entity or coder 12 may, for example, use linear prediction(s) like CELP. The bandwidth extension (BWE) coder 14 may use WESPE or another coding for generating a first HF excitation. By use of the BWE coder 14 random noise is used for generating a second HF excitation. The generation of the second HF excitation may done by a noise generator 13. Note, 13 may also be arranged as external element, i.e. separated from 14. According to embodiments, the first extended-band excitation may be generated from a time envelope derived from the band-limited signal or an output signal of the band-limited entity (12). This could be done by the bandwidth extension entity 14.

The two extended-band excitations, e.g. HF excitations (first excitations/HF excitation and second excitations/HF excitation) are combined to a mixture by the mixer 14M and output as high band signal. For example, the mixture and the mixer 14M, respectively, is controlled via a steering factor derived from a characteristic output or a parameter of the band-limited entity 12 (cf. line_{isf}).

It would found out that adding pure randomly noise (provided or generated by 13) could provide better perceptual quality. The challenge is, however, to find a way to steer the mixing between the WESPE excitation (general first excitations/HF excitation) and random noise (general second excitations/HF excitation). According to embodiments it is proposed to employ information derived from the baseline for this purpose, and more especially a voicing estimation done on the energetic contribution of these codebooks or CELP and/or coder type transmitted. Practically, this means that the mixture is controlled using a steering factor, wherein the steering factor (weighting factor) is derived or depends on the baseband speech coder (e.g. voicing decoded/coded in CELP). For this, an information from the coder 12 to the mixture 14M is provided. This information is marked by the reference numeral IsF.

An example, how the factors are set dependent on determined on determination of type “voicing” or unvoicing” is given by the below pseudo-code. For example dependent on different conditions or used coder types voiced coder type/unvoiced coder types the steering factor may be set to 0 or 0,8 or 0.25 or 0,5.

### Example

```
  if ( st−>coder_type == VOICED )
  {
    voicing = 0.8f;
  }
  if ( st−>total_brate >= ACELP_16k40 && st−>coder_type !=
  UNVOICED )
  {
    voicing = powf( voicing, 0.25f );
  }
  else if ( st−>total_brate < ACELP_16k40 && st−>total_brate >=
ACELP_9k60 && st−>coder_type != UNVOICED )
  {
    voicing = powf( voicing, 0.5f ).
```

Alternatively, a parameter received form CELP may be used:

```
float voicing = ( st−>meanVoiceFac + 1 ) * 0.5f; // derived from CELP
  if ( st−>coder_type == UNVOICED ∥ voicing < 0.f )
  {
  voicing = 0.f;
  }
  if ( voicing > 0.8f && st−>total_brate < ACELP_16k40 )
  {
  voicing = 0.8f.
```

The BWE coder 14 or the mixer 14m outputs the higher band signal excHb[i], e.g. dependent on the steering factor voicing: excHb[i]=voicing*excHb[i] 1+ (1−voicing)*noise_adj*random[i]; where excHb[i]₁ represents the first HF excitation and *noise_adj*random[i] the second HF excitation, both HF excitations multiplied with a respective steering factor “voicing” and “(1−voicing)”, respectively.

Afterwards, the high band signal of the coder 14 and low band signal of the coder 12 may be combined as will be discussed with respect to below embodiments.

Embodiments of the present invention enable to control the mixing of two types of excitations, one, for example issued from WESPE and another from a randomly generated noise. Optimal mixing is found by avoiding transmitting additional information, and this by exploiting characteristics of the baseband coder and especially CELP. By doing so, unpleasant artifacts, such as buzziness and roughness, especially for a noise signal such as noisy or on speech phenomena, can be greatly reduced.

Although embodiments have been discussed in context of coders (encoder/decoder), the principal is applicable to other audio processing types for processing a signal having a band-limited signal and a extended-band signal.

Embodiments of the present invention may be computer implemented performing the method as illustrated by FIG. 1b.

FIG. 1b shows a method 100 having the basis steps of baseband coding 110 and BWE coding 120. The baseband coding codes a lower band signal, wherein the BWE coding codes a higher band signal comprising a mixture of the first HF excitation and the second HF excitation as discussed above.

According to embodiments the method may comprise the optional step of generating or systemically generating random noise. According to an embodiment the method may comprise the step of appropriately mixing the generated WESPE excitation (first HF excitation) with a (systematically) generated random noise (second HF excitation). Furthermore, the method comprises the step of (accurately) controlling the mixture by exploiting information provided or interfereable by the baseband coder. According to embodiments, the exploiting information may be derived from the baseline for this purpose, and more especially a voicing estimation done on the energetic contribution of these codebooks or CELP and/or coder type transmitted.

Note, the BWE coding, e.g., performed by the BWE coder 14 and the baseband coding, e.g., performed by the baseband coder may both operate in a residual domain or at least one linear prediction.

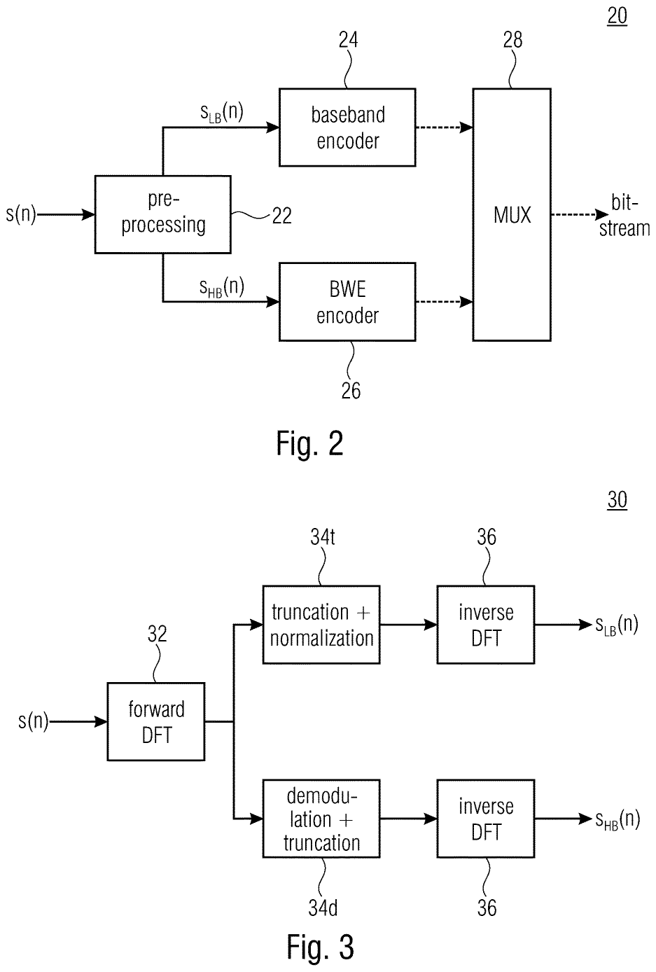

With respect to FIGS. 2 to 5 applications of the above discussed WESPE Coder enabling the bandwidth extension.

FIG. 2 shows an encoder 20, a pre-processor 22, a baseband encoder 24 and a parallel BWE encoder 26.

The input signal is first conveyed to pre-processing block 22, which is in charge of converting of doing several analyses like a pitch estimation, a voice activity detection but also to convey signals sampling rate at a proper sampling rate to the subsequent coding modules, consisting in our case to baseband coder 24 and bandwidth extension 26. For this a filter-bank, like a QMF, pseudo QMF, modulated lapped or block transforms, or simply downsampling filters in time domain can be used.

The two signals conveyed to the baseband encoder 24 and the bandwidth extension (BWE) encoder 26 are usually at sampling rates lower than the sampling rate of the input signal s(n). The low band signal S_{lb}(n) is composed of frequencies below a cross-over frequency which is usually the corresponding Nyquist frequency of its sampling-rate. On the other hand, the high band signal S_{hb}(n) is composed of frequencies above a cross-over frequency which is usually the corresponding Nyquist frequency of its sampling-rate. The HB and LB cross-over frequencies are usually the same. Therefore and in the usual case the two signals are complementary in frequency representation of the input signal and at the same time the whole multi-rate system is critically sampled. As an example, S_{lb}(n) and S_{hb}(n) are both sampled at 16 kHz, S_{lb}(n) retaining frequencies from 0 to 8 kHz, and S_{hb}(n) retaining frequencies from 8 to 16 kHz. Another alternative is to have S_{lb}(n) sampled at 12.8 kHz, composed of frequencies from 0 to 6.4 kHz and S_{hb}(n) sampled at 16 kHz composed of frequencies from 6.4 to 14.4 kHz. As in the filter-bank convention and in the subsequent description, the high-band signal (odd indexed band), is frequency reversed as illustrated in FIG. 3.

The low-band signal is conveyed to the baseband coder, which in our preferred case is a CELP-based speech coding system, as in AMR-WB or 3GPP EVS. The S_{lb}(n) signal preferably contains a broadband signal sampled at 12.8 or 16 kHz.

FIG. 3 shows a schematic block diagram of a two-band system realized with block transforms, for example DFTs. The two-band system comprises the forward DFT 32 and two parallel DFT strings. The one DFT string comprises truncation and normalization entity 34t and an inverse DFT 36, while the other string comprises a demodulator and truncation entity 34d and also an inverse DFT 36. The first string 34t plus 36 is used for the low band while the second string 34d plus 36 for the high band.

The truncation and normalization 34t of DFT spectrum serves as lowpass filtering and the Inverse DFT 36 is operating at a size corresponding to the target sampling rate for the low-band signal. For the high band, only the high frequencies are retained and copied and flipped to the baseband (aka known as demodulation, cf. 34d) before being decimated by the Inverse DFT 36 with a size corresponding to the sampling-rate of high-band signal.

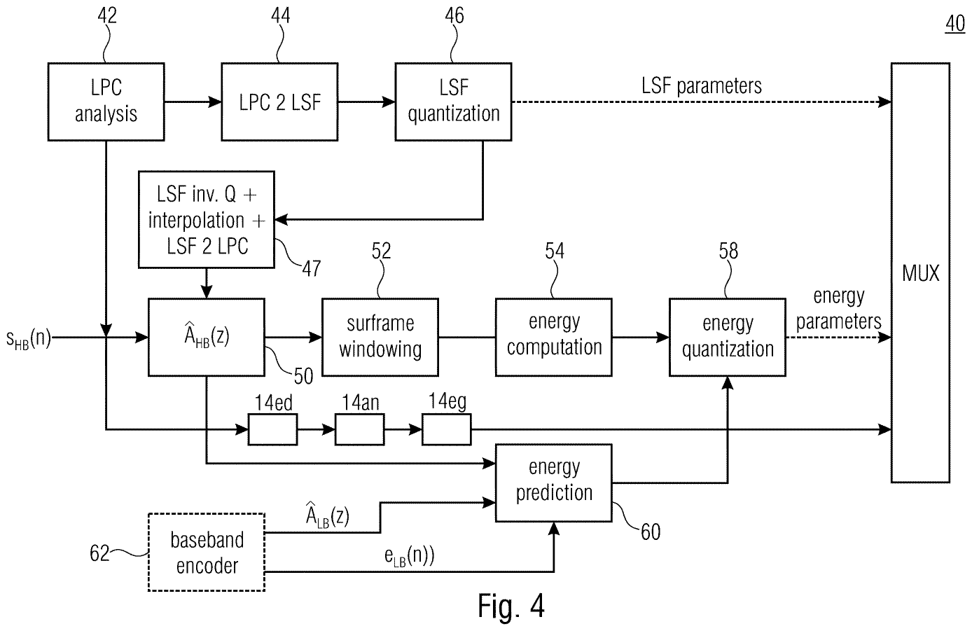

FIG. 4 illustrates a BWE encoder 40 comprising LPC analysis 42, LPC 2 LSF 44 and LSF quantization 46 enabling to output LSF parameters.

In parallel to a calculation of the LSF parameters, energy parameters are determined using the entities 50, 52 (subframe windowing), 54 (energy computation) and 56 (energy quantization). The energy quantization 56 is based on the energy computation 54 and the energy prediction 60 which gets the signal from the entity 50 and from a baseband coder 62. The entity 50 is connected with the input for the signal and the LSF quantization 46, via the entity 47.

The BWE encoder 40 receives the high-band signal S_{hb}(n) in order to extract the main salient parameters from it, namely its spectral shape and its energy. To do this, it follows a source-filter model like in CELP coding scheme and exploits the Linear Predictive Coding (LPC). LPC 42 and 44 is an adaptive filter that models the short-term linear prediction and, through duality between time and frequency domains, the spectral envelope of the signal. Quasi-optimality of LPC holds for near stationary segments, which for audio and speech signal can be considered for a duration of about 20 ms. Therefore, the signal is partitioned into 20 ms frames, and the LPC analysis 42 and parameter computation are performed at frame basis. For smoothing the transition, the LPC coefficients are further interpolated between adjacent frames, at a subframe level of duration 4 or 5 ms. The interpolation is performed by linear interpolation of LSFs (cf. 44 and 46).

An LPC analysis 42 aka short-term linear analysis is performed on S_{hb}(n) to obtain a set of LPC coefficients. Since speech and in general audio shows less structure or formant structure in the high frequencies, fewer parameters are required than for the low-band signal. In our preferred mode, an order of 8 or 10 is used for a 16 kHz sampled S_{hb}(n) signal.

The LPC analysis is performed as it can be done in baseband encoder, that means, by windowing the signal, computing the autocorrelation function up to a maximum lag corresponding to the order, before finding the optimal prediction coefficients with a recursive algorithm like Levinson-Durbin. It is worth noting that the LPC analysis windows of both low and high band can be the same and preferably time aligned, which will be an advantage in the subsequent processing steps, but also for exploiting the same lookahead.

The so-obtained LPC coefficients are then quantized and coded. Once again since the spectral envelope of the high-band is usually less structured and also perceptually less relevant, quantization resolution can be lowered for the BWE coding compared to the baseband coding. For the quantization and the coding, a Vector quantization or a multi-stage vector quantization is preferably applied after conversion of LPC coefficients to LSFs. Precomputed LSF means, obtained during an offline analysis on a dataset, is removed before quantization as well as a 1st order prediction obtained from the previously transmitted set of LSFs. The LSF residual are then vector quantized using from 8 to 16 bits per frame in a preferred embodiment. The quantized LSFs are converted to quantized LPC coefficients to form the LPC analysis filter Â_{HB}(z) used to whiten the high-band signal and obtain the residual signal e_{HB}(n):

$${e}_{HB} ( n ) = {s}_{HB} ( n ) - {\sum }_{i = 1}^{{M}_{HB}} {a}_{i} {s}_{HB} ( n - i ) , n = 0 , ... , L - 1 ,$$

where M_{HB} is the LPC order, and L_{sub}, the size of the subframe for which the LPC coefficients are constant (L_{sub}=80 samples for 5 ms subframe at 16 kHz).

The energy of e_{HB}(n) is then computed (cf. 54) and coded per sub-frame of 4 to 5 ms (5 ms in our preferred mode) using rectangular and non-overlapping windows (cf. 52). This way, an energy parameter can be transmitted at every 4/5 ms.

In order to save transmitted bits, the energy is not coded and quantized directly, but after a prediction exploiting the information derived from the low band. Only the residue of the energy prediction is then quantized. This information may be shared with the decoder, since the inverse prediction may be performed on the decoder side. For this purpose, if the baseband code is CELP-based, as in a preferred mode, the ALB (z) low-band LPC analysis filter can be reused, using the quantized and transmitted LPC coefficients, as well as the coded excitation. Analysis of these two components, especially in the high frequencies of the low band, around the Nyquist frequency, gives a robust estimate of the high-band energy and the residual of the high-band LPC analysis. For a 20 ms framing, a set of 4 energy parameters are then obtained, and can be coded for example with a vector quantization using 7 bits. For even lower bit demand, the energy can be averaged (geometrically in the preferred mode) over the frame size for the 4 subframes, to obtain 1 single value per frame to transmit. A 4 bit quantization is then enough. In the extreme case, only the estimate can used at the decoder without additional guidance from the encoder, corresponding then to a Obit quantization.

Possible BWE parameters and bit allocations are

| | Resolution | Bits | Bit-rate (kbps) |
|---|---|---|---|
| LSF parameters | 20 ms | 0/8/8/8/16 | 0/0.4/0.4/0.4/0.8 |
| Energy parameters | 5/20 ms | 0/0/4/7/7 | 0/0/0.2/0.35/0.35 |
| Total | | 0/8/12/15/23 | 0/0.4/0.6/0.75/1.15 |

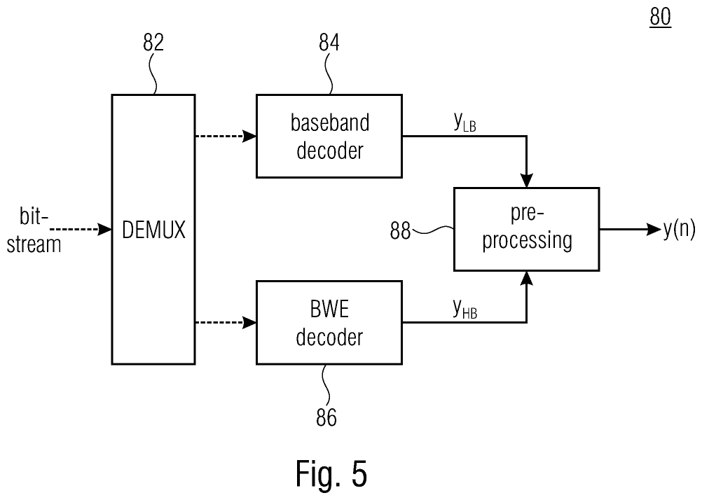

With respect to FIG. 5, a BWE decoder will be discussed. It comprises the demultiplexer 82, a baseband decoder 84 and a BWE decoder 86. Furthermore, the two decoded signals y_{lb} and y_{hb} are combined by the pre-processor 88 so as to obtain the signal y(n).

From the transmitted parameters, i.e. the coded LPC coefficients and coded energies, an artificially generated excitation is energy normalized and scaled, and then spectrally shaped by the synthesis LPC filter 1/Â_{HB}(z).

The generated y_{HB}(n) signal is then combined to the decoded low-band signal y_{LB}(n) to form the reconstructed signal y(n), as it is shown in FIG. 5, reference number 88. It can be achieved using a filter-bank, block transforms or time-domain up-sampling. In the preferred embodiment, a complex-valued low-delay filter bank (CLDFB) as in described EVS, is used, which allows to perform additional post-processing steps in the filter-bank domain before combining the two components and transforming the signal back to the time-domain and at the desired sampling rate.

Below, the embodiment for excitation generation will be discussed.

HB excitation is usually generated artificially, in the sense that little or no parameters are transmitted for it. To generate a suitable excitation, the decoded low-band signal is used intensively. In the preferred example, where LB excitation is already available in CELP, it could be as simple as copying coded LB excitation for generating the HB excitation, if both signals are at the same sampling rate. This then corresponds to a mirroring replication in the frequency domain, since the high-band signal is frequency inverted in our case.

This leads to decent quality, but also to some obvious problems: harmonicity is often overestimated, and generated harmonics in the high-band do not necessarily correspond to the natural subharmonics of the fundamental frequency. It is also possible to apply a non-linear operation by increasing the excitation and applying a non-linear operation, then sub-sampling the component at high frequency. This approach is the one adopted in EVS in the Time-Domain BWE. In our preferred version, the method known as WESPE is adopted, giving greater control over the final result and the amount of harmonicity injected. WESPE is adopted in the invention to work in the above-described framework, i.e. the LPC residual domain and also applied over the code excitation of CELP. As discussed above, the embodiments provide a computer implemented method, e.g., the computer implemented method 100 with or without the optional steps. Below, the method will be discussed by use of pseudo code.

```
Pseudo-code:
  // Generate gaussian white noise and compute energies of the two excitations
  float nrg_noise = FLT_MIN;
  float nrg_wespe = FLT_MIN;
  for ( int32_t i = 0; i < L_FRAME16k; i++ )
  {
    // Central theorem for mimicking gaussian distribution
    random[i] = (float) own_random( &( st−>hAcelpSt−>seed_acelp ) );
    random [i] += (float) own_random( &( st−>hAcelpSt−>seed_acelp ) );
    random[i] += (float) own_random( &( st−>hAcelpSt−>seed_acelp ) );
    nrg_noise += random [i] * random[i];
    nrg_wespe += excHb[i] * excHb[i];
  }
  float noise_adj = sqrtf( nrg_wespe / nrg_noise );
  // derive optimal mixing factor employing CELP information
  float voicing = ( st−>meanVoiceFac + 1 ) * 0.5f; // derived from CELP
  if ( st−>coder_type == UNVOICED ∥ voicing < 0.f )
  {
    voicing = 0.f;
  }
  if ( voicing > 0.8f && st−>total_brate < ACELP_16k40 )
  {
    voicing = 0.8f;
  }
  // or maybe coder_type dependent
  if ( st−>coder_type == VOICED )
  {
    voicing = 0.8f;
  }
  if ( st−>total_brate >= ACELP_16k40 && st−>coder_type != UNVOICED )
  {
    voicing = powf( voicing, 0.25f );
  }
  else if ( st−>total_brate < ACELP_16k40 && st−>total_brate >= ACELP_9k60 && st−>coder_type
!= UNVOICED )
  {
    voicing = powf( voicing, 0.5f );
  }
  // Perform the actual mixing
  for ( int32_t i = 0; i < L_FRAME16k; i++ )
  {
    excHb[i] = voicing * excHb[i] + ( 1 − voicing ) * noise_adj * random[i];
  }
```

According to another embodiment in the above discussed principle comprising the noise mixing may be combined for an audio processor for extended the audio bandwidth of a band-limited audio signal. This processor may be used in context of WESPE coders for coding a signal. The audio processor for extended the audio bandwidth of a band-limited audio signal comprises an envelope determiner, an analyzer for analyzing the time (temporal) envelope, an excitation generator, an extended band generator, and a combiner.

Please note that a power envelope is also referred to as time envelope. As discussed above, the bandwidth extension entity 14 is configured to generate the first extended band excitation from a time envelope derived from the band-limited signal or an output signal of the band-limited entity. The below discussion will describe how this may be done in detail using three sub-entities of the bandwidth extension entity 14, namely the envelope determiner 14ed, the analyzer 14an and the excitation generator 14eg which are illustrated in FIG. 4.

According to embodiments, the envelope determiner is configured for determining a time (temporal) envelope of at least a portion of a linear prediction residual of the band-limited audio signal or an excitation modelling the linear prediction residual of the band-limited audio signal (e.g., by peak picking and/or downsampling). For example, the envelope determiner may be part of 14. In FIG. 4 it is marked by 14ed and informatively coupled to the analyzer 14an. The analyzer 14an is configured for analyzing the time (temporal) envelope to determine certain values of the temporal envelope. For example the certain values may be values characteristic for the temporal envelope, e.g. a predetermined amount of values (having a predetermined distance) enabling to describe the envelope. The excitation generator is configured for generating an excitation (signal, e.g. LPC residual/excitation signal of a low-band/baseband portion), e.g. by placing pulses in relation to the determined certain values, wherein the pulses are weighted using weights derived from the temporal envelope. The extended band generator 14eg (cf. FIG. 4) is configured for generating an extended-band audio signal by processing the generated excitation. The combiner combining the band-limited audio signal with the generated extended-band audio signal to obtain a frequency enhanced audio signal.

According to further embodiments a different output signal of the band-limited entity 12 may be used, e.g., the band-limited signal directly.

Additionally or alternatively, the coder may be part of a processor like an encoder for coding a signal comprising a LF signal and a HF signal, the processor or encoder comprising: a calculator configured to perform energy prediction of the HF signal based on LPC coefficients; and a processor or coder is configured to encode a residual of the signal using the energy prediction and an offset; wherein the offset is dependent on a bit-rate.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, some one or more of the most important method steps may be executed by such an apparatus.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

The above described embodiments are merely illustrative for the principles of the present invention. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An audio processor for processing a signal, the audio processor comprising:
a band-limited entity configured to provide a band-limited signal; and
a bandwidth extension entity configured to provide an extended-band signal, the extended-band signal comprising a mixture of a first extended-band excitation and a second extended-band excitation;
wherein the bandwidth extension entity is configured to generate the first extended-band excitation; and
a noise generator configured to generate random noise as the second extended-band excitation;
wherein the mixture is controlled via a steering factor derived from a characteristic output or a parameter of the band-limited entity;
wherein the bandwidth extension entity is configured to generate the first extended-band excitation from a temporal envelope derived from the band-limited signal, especially a linear prediction residual of the band-limited signal or of an excitation modelling the linear prediction residual of the band-limited signal, by use of an envelope determiner;
wherein the bandwidth extension entity is configured to generate the first extended-band excitation by placing pulses in relation to values, wherein the values are determined by an analyzer analyzing the temporal envelope, the pulses being weighted using weights derived from the temporal envelope.

2. Audio processor according to claim 1, wherein the bandwidth extension entity is configured for exploiting some characteristics derived of the band-limited entity.

3. Audio processor according to claim 1, wherein the band-limited entity and the bandwidth extension entity operate in a LPC residual domain involving a linear prediction.

4. Audio processor according to claim 1, wherein the band-limited entity and the bandwidth extension entity are configured for Linear Prediction Coding.

5. Audio processor according to claim 1, wherein the band-limited entity comprises a long-term prediction, a pitch analysis or a tonal analysis of the band-limited signal.

6. Audio processor according to claim 1, wherein the band-limited entity comprises one of: a baseband coder, a voice coder or a speech coder or a CELP coder.

7. Audio processor according to claim 1, wherein the steering factor is a voicing factor or a prediction gain or a coder type or a pitch gain or a tonality factor derived from the band-limited signal.

8. Audio processor according to claim 1, wherein the bandwidth extension entity comprises the envelope determiner for determining the temporal envelope and the analyzer for analyzing the temporal envelope;

9. An audio coder for coding an audio signal, the coder comprising:
a band-limited entity configured to code the signal to acquire a band-limited signal; and
a bandwidth extension entity configured to code an extended-band signal, and comprising a mixture of a first extended-band excitation and a second extended-band excitation;
wherein the bandwidth extension entity is configured to generate the first extended-band excitation and a noise generator configured to generate random noise as the second extended-band excitation;
wherein the mixture is controlled via a steering factor derived from a characteristic output or parameter of the band-limited entity;
wherein the bandwidth extension entity is configured to generate the first extended-band excitation from a temporal envelope derived from the band-limited signal, especially a linear prediction residual of the band-limited signal or of an excitation modelling the linear prediction residual of the band-limited signal, by use of an envelope determiner;
wherein the bandwidth extension entity is configured to generate the first extended-band excitation by placing pulses in relation to values, wherein the values are determined by an analyzer analyzing the temporal envelope, the pulses being weighted using weights derived from the temporal envelope.

10. Audio processor according to claim 1, wherein the bandwidth extension entity comprises a mixer configured to combine the first extended-band excitation and to second extended-band excitation taking into account the steering factor to acquire the mixture.

11. Decoder comprising the audio processor according to claim 1 and comprising a baseband decoder for decoding the band-limited signal by use of the band-limited entity and a bandwidth extension decoder for decoding the extended-band signal, wherein the bandwidth extension decoder comprises the bandwidth extension entity.

12. Encoder comprising the audio processor according to claim 1 and comprising a baseband encoder for encoding the band-limited signal by use of the band-limited entity and a bandwidth extension encoder for encoding the extended-band signal, wherein the bandwidth extension encoder comprises the bandwidth extension entity.

13. Method for processing a signal, the method comprising:
providing a band-limited signal; and
providing an extended-band signal, the extended-band signal comprising a mixture of a first extended-band excitation and a second extended-band excitation;
generating the first extended-band excitation from a temporal envelope derived from the band-limited signal, especially a linear prediction residual of the band-limited signal or of an excitation modelling the linear prediction residual of the band-limited signal; and generating random noise as the second extended-band excitation;
wherein the mixture is controlled via a steering factor derived from a characteristic output or parameter of the band-limited entity;
wherein the generating the first extended-band excitation comprises placing pulses in relation to values, wherein the values are determined by analyzing the temporal envelope, the pulses being weighted using weights derived from the temporal envelope.

14. A non-transitory digital storage medium having a computer program stored thereon to perform the method for processing a signal, the method comprising:
providing a band-limited signal; and
providing an extended-band signal, the extended-band signal comprising a mixture of a first extended-band excitation and a second extended-band excitation;
generating the first extended-band excitation from a temporal envelope derived from the band-limited signal, especially a linear prediction residual of the band-limited signal or of an excitation modelling the linear prediction residual of the band-limited signal; and generating random noise as the second extended-band excitation;
wherein the mixture is controlled via a steering factor derived from a characteristic output or parameter of the band-limited entity;
wherein the generating the first extended-band excitation comprises placing pulses in relation to values, wherein the values are determined by analyzing the temporal envelope, the pulses being weighted using weights derived from the temporal envelope,
when said computer program is run by a computer.
